(19) United States
(12) Patent Application Publication
(10) Pub. No.: US 2016/0333550 A1
(43) Pub. Date: Nov. 17, 2016

(54) Rubber Stopper for Opening-Closing Cover

(71) Applicant: Caterpillar SARL, Geneva (CH)

(72) Inventors: Kazumasa Matsumura, Tokyo (JP); Eiji Akahane, Tokyo (JP)

(73) Assignee: Caterpillar SARL, Geneva (CH)

(21) Appl. No.: 15/110,302

(22) PCT Filed: Jan. 8, 2015
(86) PCT No.: PCT/EP2015/050259

§ 371 Date: Jul. 7, 2016

(30) Foreign Application Priority Data
Jan. 10, 2014 (JP) 2014-003096

(51) Int. Cl. E02F 9/08; E05C 19/14; E05B 65/00; E05F 5/02

(52) U.S. Cl. CPC E02F 9/0891; E05F 5/022; E05C 19/14; E05B 65/006; E02F 3/32

(57) ABSTRACT

A rubber stopper is formed with a body part having an attach surface part to attach a cover body, a mounting leg part to put into a mounting part hole formed on the mounting part penetratingly and a recessed portion for tucking formed on the attach surface part positioned aligned with the mounting leg part in the front back direction, and the rubber stopper is mounted to the mounting part by putting the mounting leg part to the mounting part hole.

### TECHNICAL FIELD

The present invention relates to a technical field of a rubber stopper for an opening-closing cover such as an engine hood which is provided in a working machine such as a construction machine.

### BACKGROUND ART

In general, some working machines such as construction machines include a cover body that covers a housing room (an engine room or the like) in which apparatuses such as an engine are housed, the cover body having an opening for maintenance, an opening-closing cover (an engine hood or the like) which can be opened and closed and which covers the opening, and lock means for locking the opening-closing cover in a closed position.

When a working machine with such an opening-closing cover is a construction machine such as an excavator, the opening-closing cover vibrates in conjunction with vibration of a machine body associated with traveling or operation in a rough working field. Then, noise may be generated, a seal material which forms a seal between the opening-closing cover and the cover body may be prematurely degraded, and the locking provided by the lock means maybe released. Thus, a technique is conventionally known in which a seal member formed of an elastic material that comes into contact with a cover body side when the opening-closing cover is locked in the closed position is provided on a lower surface side of the opening-closing cover, and in which the seal member has a function to reduce the vibration of the opening-closing cover and a function to serve as a reinforcement member that enables the lock means to be held in a lock state (see, for example, Patent Literature 1).

[Patent Literature 1] Japanese Patent Application Laid-open No. H8-85972

### DISCLOSURE OF THE INVENTION

In the technique disclosed in Patent Literature 1, the elastic material (seal member) is anchored to the lower surface of the engine hood. However, if means for anchoring the elastic material involves sticking using an adhesive or the like, when the elastic material is to be replaced due to degradation or damage, the already stuck elastic material needs to be peeled off before a new elastic material is stuck. This is disadvantageously cumbersome and needs much time and effort. Accordingly, fastening the elastic material via screws is proposed. However, in this case, a fastening operation needs to be performed until the screws deeply penetrate the elastic material so as to prevent the tightened screws from coming into contact with the cover body even when the elastic material is elastically deformed. Thus, disadvantageously, the fastening operation is difficult to achieve, and in the above-described construction machine, the screws are likely to be loosened by vibration of the machine body. These are problems to be solved by the present invention.

With the foregoing in view, the present invention has been developed in order to solve the above-described problems. An invention according to claim 1 is a rubber stopper for an opening-closing cover in a working machine including: a cover body which covers a housing room in which apparatuses are housed, the cover body having an opening; an opening-closing cover which is able to be opened and closed and which covers the opening; and lock means for holding the opening-closing cover in a closed position, the rubber stopper being provided on a first member, which is one of the opening-closing cover and the cover body, and coming into abutting contact with a second member, which is the other of the opening-closing cover and the cover body, in an elastic pressing manner with the opening-closing cover locked in a closed position, and the rubber stopper including: a main body portion including, on a front surface side thereof, an abutting-contact surface portion that comes into abutting contact with the second member; a mounting leg portion projecting from a rear surface side of the main body portion and fitted into amounting hole drilled in the first member so as to penetrate the first member in order to mount the rubber stopper on the first member; and a press-in recess portion formed in the abutting-contact surface portion in front-to-back alignment with the mounting leg portion.

An invention according to claim 2 is the rubber stopper for an opening-closing cover according to claim 1 in which the main body portion is shaped like a rectangular parallelepiped, whereas the mounting leg portion is shaped like an ellipse in cross section such that a longitudinal direction of the mounting leg portion is parallel to a short side direction of the main body portion, and the mounting leg portion is provided in plurality in a long side direction of the main body portion.

An invention according to claim 3 is the rubber stopper for an opening-closing cover according to claim 1 or claim 2 in which the abutting-contact surface portion of the rubber stopper is provided with a groove portion formed such that a contact area between the abutting-contact surface portion and the second member is smaller than a contact area between the rear surface of the main body portion and the first member.

An invention according to claim 4 is the rubber stopper for an opening-closing cover according to claim 3 in which the groove portion is formed to lead to an outer periphery of the abutting-contact surface portion.

An invention according to claim 5 is the rubber stopper for an opening-closing cover according to any one of claims 1 to 4 in which the mounting leg portion of the rubber stopper includes, at an outer peripheral portion thereof, a locking projecting portion that is locked, in a retaining manner, in a mounting hole drilled in the first member, whereas the press-in recess portion is formed to penetrate the main body portion and lead to an inside of the mounting leg portion provided on an inner peripheral side of the locking projecting portion.

The invention according to claim 1 allows the rubber stopper to be easily and efficiently mounted on the first member, and, for example, when the rubber stopper is mounted using screws, can avoid a situation where vibration of the machine body or the like makes the screws loose, causing the rubber stopper to be detached.

The invention according to claim 2 can reliably regulate movement of the main body portion in the long side direction and the short side direction.

According to the invention according to claim 3, even if the housing room may become hot like an engine room to cause the rubber stopper to stick to the first member or the second member, a force by which on the abutting-contact surface portion sticks to the second member is lower than a force by which the rear surface of the main body portion sticks to the first member. The invention can thus prevent a situation where the abutting-contact surface portion sticks to the second member to cause the rubber stopper to be detached from the first member.

The invention according to claim 4 can prevent a situation where sand and gravel adhere to the abutting-contact surface portion of the rubber stopper for an opening-closing cover and rub and peel off a painted surface of the second member, even when the rubber stopper is provided in a working machine such as a construction machine which is used in a field with much sand and gravel.

The invention according to claim 5 can reliably prevent the rubber stopper from being inadvertently detached and allows the rubber stopper to be easily mounted because the locking projecting portion passes easily through the mounting hole.

### BRIEF DESCRIPTION OF THE DRAWINGS

FIG. 1 is a side view of an excavator.

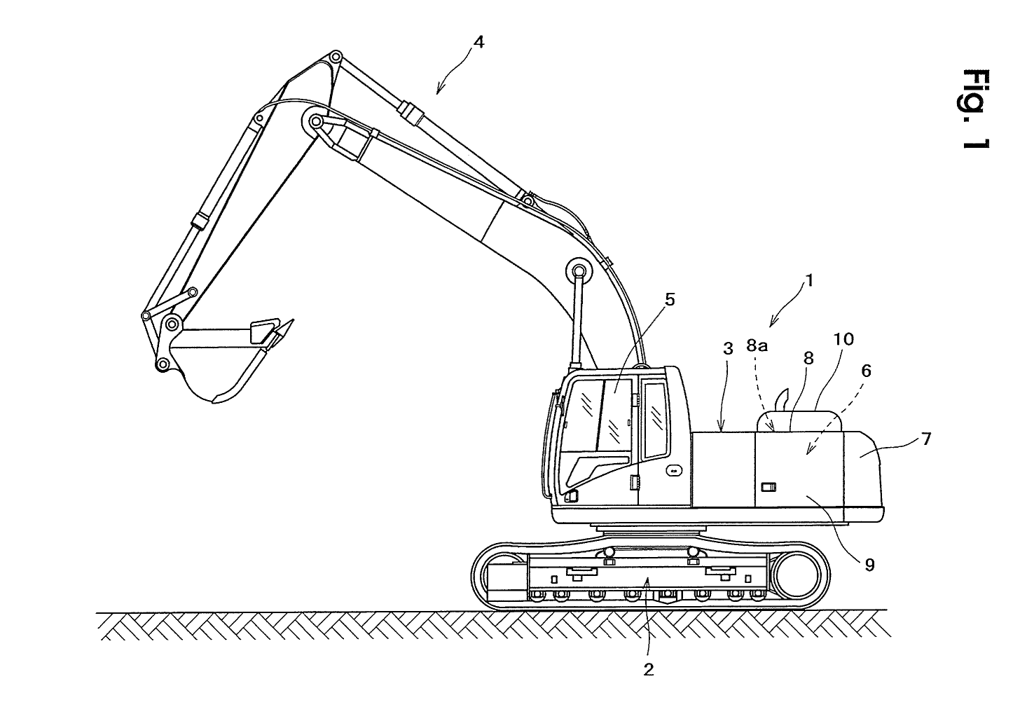

FIG. 2 is a perspective view of an engine hood as seen from below.

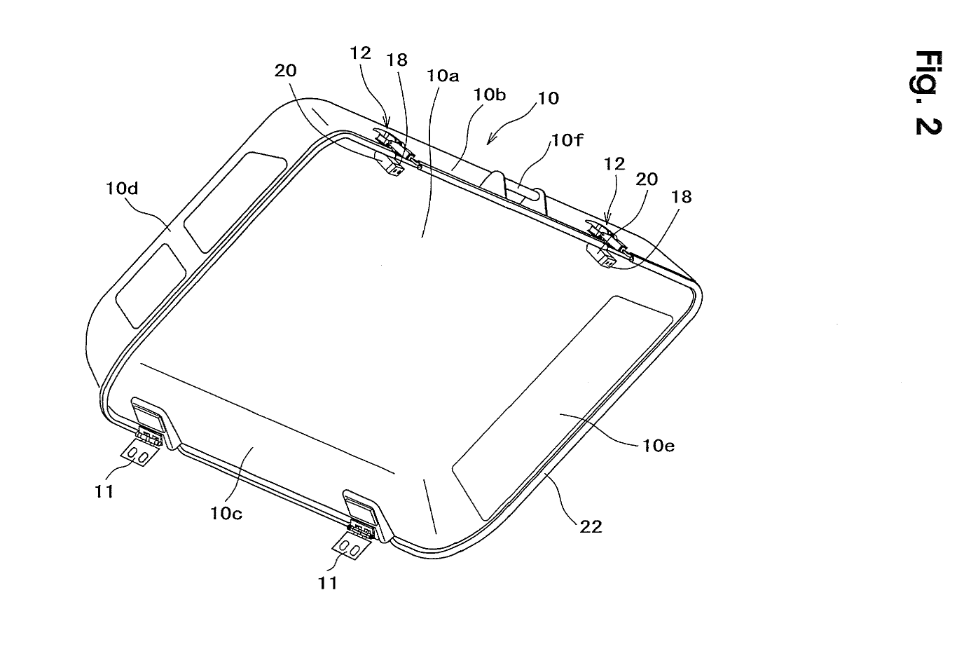

FIG. 3 is a perspective view of lock means.

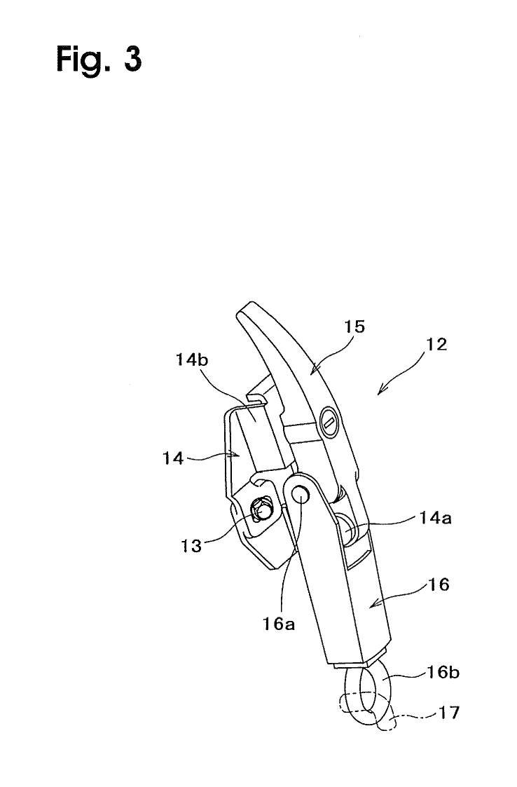

FIG. 4(A) is a cross-sectional view of a main part of a state where an engine hood is locked in a closed position, and FIG. 4(B) is a cross-sectional view of a main part of a state before the engine hood is locked in the closed position.

FIG. 5 is a cross-sectional view depicting a seal member installation portion.

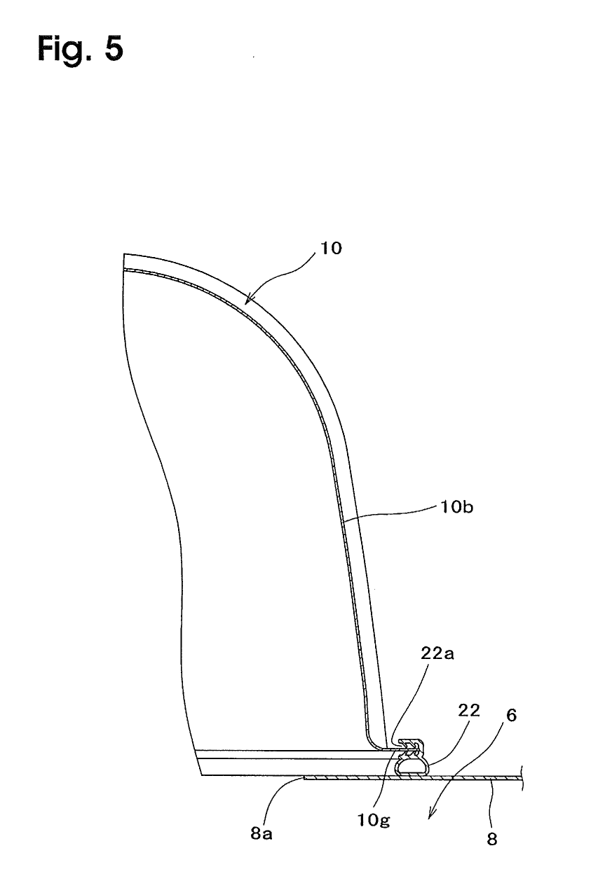

FIG. 6(A), FIG. 6(B), FIG. 6(C), and FIG. 6(D) are a front view, a plan view, aside view, and a rear view of a rubber stopper, and FIG. 6(E) is a cross-sectional view taken along line X-X in FIG. 6(B).

FIG. 7(A) is a perspective view of the rubber stopper as seen from a front surface side, FIG. 7(B) is a perspective view of the rubber stopper as seen from a rear surface side, and FIG. 7(C) is a diagram depicting that the rubber stopper is mounted on a mounting member.

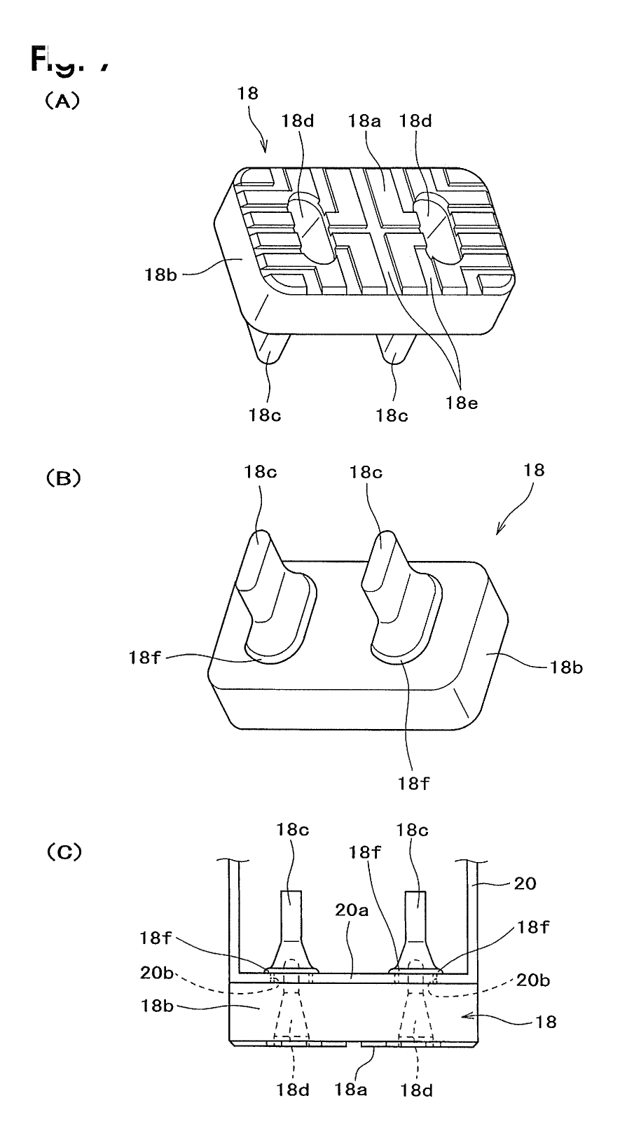

### BEST MODE FOR CARRYING OUT THE INVENTION

An embodiment of the present invention will be described based on the drawings. In the drawings, 1 denotes an excavator that is an example of a working machine. The excavator 1 includes a crawler type lower traveling body 2, an upper slewing body 3 supported by the lower traveling body so as to be able to be slewed, and a front working portion 4 installed on the upper slewing body 3. The upper slewing body 3 further includes a cab 5 serving as an operating room, an engine room 6 in which various apparatuses (not shown) such as an engine are housed, and a counterweight 7.

The engine room 6 is covered with an upper cover 8 at a top side and with side covers 9 at laterally opposite sides. The upper cover 8 has an opening 8a for maintenance through which inspection, repair, and the like are performed on the apparatuses housed in the engine room 6. The opening 8a for maintenance is covered with an engine hood 10 that can be opened and closed.

The engine room 6 corresponds to a housing room according to the present invention. The upper cover 8 corresponds to a cover body according to the present invention. The opening 8a for maintenance corresponds to an opening according to the present invention. The engine hood 10 corresponds to an opening-closing cover according to the present invention.

The engine hood 10 is shaped like a rectangular box having an upper surface portion 10a and a front side surface portion 10b, a rear side surface portion 10c, a left side surface portion 10d, and a right side surface portion 10e and which is open at a bottom side thereof. The engine hood 10 is mounted on the upper cover 8 at one edge side (in the embodiment, a lower edge portion of the rear side surface portion 10c) via a hinge 11 so as to be able to be opened, closed, and swung. The engine hood 10 includes lock means 12 at the other edge side to hold the engine hood 10 in a closed position. In the drawing, 10f denotes a handle mounted on the front side surface portion 10b so as to be gripped to open or close the engine hood 10.

The lock means 12 is a lateral pair of lock means according to the embodiment and is configured using members such as a mounting bracket 14 fixed to the front side surface portion 10b of the engine hood 10 via bolts 13, and a first locking member 15 and a second locking member 16 that are described below.

The first locking member 15 is supported at a base end portion thereof by a support piece 14a mounted at a lower portion of the mounting bracket 14 so that the first locking member 15 can be swung via a first support shaft 15a. On the other hand, in an area closer to a leading end of the first locking member 15 than the first support shaft 15a, the second locking member 16 is supported at an upper portion thereof so as to be able to be swung via a second support shaft 16a. Moreover, the first locking member 15 includes, in an area closer to the leading end than the second support shaft 16a, a locking portion 15b that is detachably locked on a locking receiving portion 14b formed at an upper portion of the mounting bracket 14.

Furthermore, the second locking member 16 is supported by the first locking member 15 so as to be able to be swung as described above, and on the other hand, includes, at a bottom portion thereof, a ring portion 16b that is detachably locked on a hook 17 fixedly provided in the engine room 6.

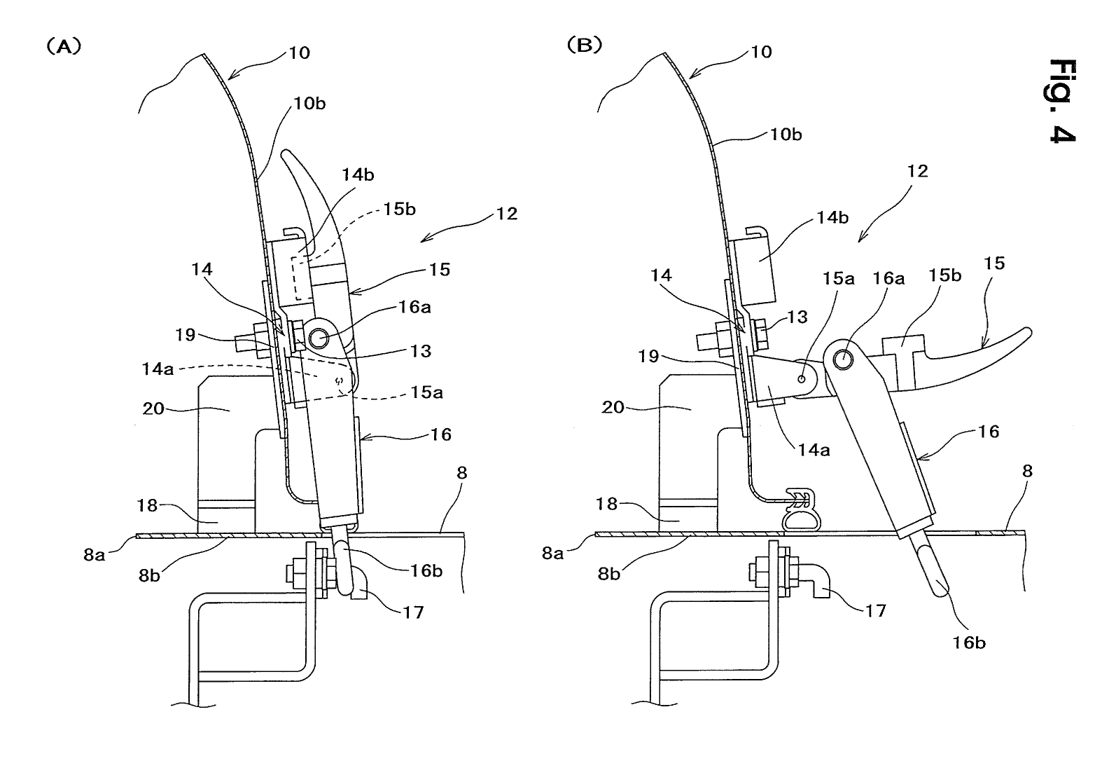

The lock means 12 is used as follows to hold (lock) the engine hood 10 in the closed position. In an unlocked state depicted in FIG. 4(B), the ring portion 16b at the bottom portion of the second locking member 16 is locked on the hook 17. Moreover, the leading end side of the first locking member 15 is swung upward around the first support shaft 15a to lock the locking portion 15b of the first locking member 15 on the locking receiving portion 14b of the mounting bracket 14. Thus, as depicted in FIG. 4(A), the first locking member 15 is locked on the locking receiving portion 14b fixed to the engine hood 10 side, whereas the second locking member 16 is locked on the hook 17 fixed to the engine room 6 side. As a result, the engine hood 10 can be held in the closed position.

On the other hand, 18 denotes a rubber stopper including an elastic material. The rubber stopper 18 is mounted on the engine hood 10 via a support plate 19 and a mounting member 20. The support plate 19 is positioned on a rear surface side of the front side surface portion 10b of the engine hood 10 and behind the mounting bracket 14 and fixed using the bolt 13 that fixes the mounting bracket 14. The mounting member 20 is anchored to the support plate 19 at a base end portion thereof by welding or the like. The mounting member 20 includes, on a leading end side thereof, a mounting surface portion 20a that is placed, via a space, opposite an upper cover 8 provided on an outer peripheral side of an opening 8a for maintenance when the engine hood 10 is closed. Moreover, the mounting surface portion 20a has a pair of mounting holes 20b drilled therein and in which mounting leg portions 18c of the rubber stopper 18 described below are buried. In the embodiment, the mounting member 20 corresponds to one of an opening-closing cover and a cover body according to the present invention. The upper cover 8 corresponds to the other of the opening-closing cover and the cover body according to the present invention.

The rubber stopper 18 includes a main body portion 18b having, on a front surface side thereof, an abutting-contact surface portion 18a that comes into abutting contact with the upper cover 8 provided on the outer peripheral side of the opening 8a for maintenance when the engine hood 10 is closed, the mounting leg portions 18c projecting from a rear surface side of the main body portion 18b and which is fitted into the mounting holes 20b of the mounting member 20 so as to penetrate the mounting member 20, and press-in recess portions 18d formed in the abutting-contact surface portion 18a in front-to-back alignment with the mounting leg portions 18c. An abutting-contact target surface 8b described below refers to an outer peripheral side portion of the opening 8a for maintenance of the upper cover 8 with which the abutting-contact surface portion 18a of the rubber stopper 18 comes into abutting contact.

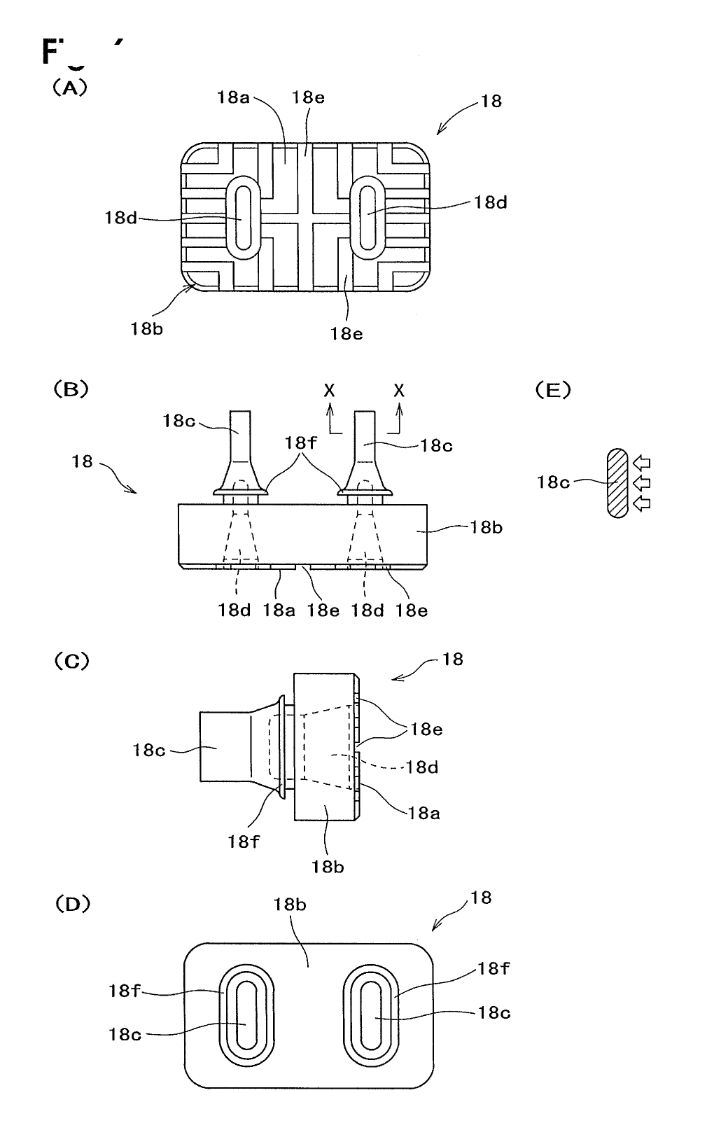

The main body portion 18b is shaped like a rectangular parallelepiped with short sides, long sides, and a height. The front surface side of the main body portion 18b provides the abutting-contact surface portion 18a, and the mounting leg portions 18c project from the rear surface side of the main body portion 18b. The mounting leg portion 18c is shaped like an ellipse in cross section such that a longitudinal direction of the mounting leg portion 18c is parallel to a short side direction of the main body portion 18b. A plurality of (in the embodiment, two) the mounting leg portions 18c is provided in a long side direction of the main body portion 18b. Since the mounting leg portion 18c is thus shaped like an ellipse in cross section such that a longitudinal direction of the mounting leg portion 18c is parallel to a short side direction of the main body portion 18b, the main body portion 18b can receive a load imposed thereon in the long side direction (the load imposed in the direction of an arrow depicted in FIG. 6(E)) in a distributed manner. This enables an increase in resistance to displacement of the main body portion 18b in the long side direction. Moreover, since a plurality of the mounting leg portions 18c is provided in the longitudinal direction of the main body portion 18b, movement of the main body portion 18b in the long and short side directions can be regulated, avoiding detachment of the abutting-contact surface portion 18a from the abutting-contact target surface 8b of the upper cover 8.

Furthermore, the mounting leg portion 18c includes, at an outer peripheral portion thereof, an annular locking projecting portion 18f that is locked on a rear surface of the mounting surface portion 20a in a retaining manner when the mounting leg portions 18c are inserted into the mounting holes 20b until the rear surface of the main body portion 18b comes into abutting contact with the mounting surface portion 20a of the mounting member 20. A leading end side of the mounting leg portion 18c is formed to be longer than the locking projecting portion 18f so as to project through the mounting hole 20b when the mounting leg portion 18c is inserted through the mounting hole 20b, and can thus be pulled in an insertion direction.

On the other hand, the press-in recess portion 18d is formed in the abutting-contact surface portion 18a in front-to-back alignment with the mounting leg portion 18c as described above. When the mounting leg portion 18c is inserted into the mounting hole 20b, the insertion of the mounting leg portion 18c is facilitated by pushing the press-in recess portion 18d. The press-in recess portion 18d is formed to penetrate the main body portion 18b and lead to the inside of the mounting leg portion 18c provided on an inner peripheral side of the locking projecting portion 18f. Thus, when the locking projecting portion 18f passes through the mounting hole 20b during the insertion of the mounting leg portion 18c, the locking projecting portion 18f can be easily deformed so as to escape toward the inside of the mounting leg portion 18c. Thus, the locking projecting portion 18f easily passes through the mounting hole 20b, allowing the rubber stopper 18 to be easily mounted on the mounting member 20.

Moreover, the abutting-contact surface portion 18a has a plurality of groove portions 18e. Since the groove portions 18e are formed in the abutting-contact surface portion 18a, the contact area between the abutting-contact surface portion 18a and the abutting-contact target surface 8b of the upper cover 8 is set smaller than the contact area between the rear surface of the main body portion 18b and the mounting surface portion 20a of the mounting member 20. The setting is such that, even when heat in the engine room 6 may cause the rubber stopper 18 to stick to the abutting-contact target surface 8b of the upper cover 8 or the mounting surface portion 20a of the mounting member 20, a sticking force on the side of the abutting-contact target surface 8b of the upper cover 8 is lower than a sticking force on the side of mounting surface portion 20a of the mounting member 20. This allows avoidance of a situation where the abutting-contact surface portion 18a sticks to the painted surface of the abutting-contact target surface 8b, causing the rubber stopper 18 to detach from the mounting member 20.

The plurality of groove portions 18e formed in the abutting-contact surface portion 18a is all formed to lead to the outer periphery of the abutting-contact surface portion 18a. This allows sand and gravel to be discharged to the outer peripheral side of the abutting-contact surface portion 18a via the groove portions 18e. Thus, even in a case of the rubber stopper 18 for the engine hood 10 provided in a working machine such as the excavator 1 which is used in a field with much sand and gravel, a situation can be prevented where sand and gravel adhere to the abutting-contact surface portion 18a of the rubber stopper 18 and rub and peel off the painted surface of the abutting-contact target surface 8b of the upper cover 8.

The rubber stopper 18 is mounted on the mounting surface portion 20a of the mounting member 20 by inserting the mounting leg portions 18c into the respective mounting holes 20b until the rear surface of the main body portion 18b comes into abutting contact with the mounting surface portion 20a of the mounting member 20. In this case, the insertion of the mounting leg portion 18c is facilitated by inserting the leading end side of the mounting leg portion 18c into the mounting hole 20b and then pulling the leading end of the mounting leg portion 18c projecting through the mounting hole 20b or pushing the press-in recess portion 18d formed in the abutting-contact surface portion 18a. Furthermore, the locking projecting portion 18f is deformed so as to escape toward the inside of the mounting leg portion 18c and thus passes easily through the mounting hole 20b as described above. Thus, the rubber stopper 18 can be easily mounted on the mounting member 20 in a retaining manner.

The rubber stopper 18 mounted on the mounting member 20 is configured such that the abutting-contact surface portion 18a comes into abutting contact with the abutting-contact target surface 8b (the outer peripheral portion of the opening 8a for maintenance of the upper cover 8) of the upper cover 8 when the engine hood is closed as described above. Furthermore, the rubber stopper 18 mounted on the mounting member 20 is set such that, when the lock means 12 locks the engine hood 10 in the closed position, the main body portion 18b is elastically compressed to bring the abutting-contact surface portion 18a into abutting contact with the abutting-contact target surface 8b of the upper cover 8 in an elastic pressing manner. The rubber stopper 18, which comes into abutting contact with the upper cover 8 in an elastic pressing manner, allows reliable suppression of vibration of the engine hood 10 caused by vibration of the machine body.

Moreover, the front, rear, left, and right side surface portions 10b to 10e of the engine hood 10 each have, at a lower edge portion thereof, a flange portion 10g opposite to the upper cover 8 provided on the outer peripheral side of the opening 8a for maintenance. When the lock means 12 locks the engine hood 10 in the closed position, the flange portion 10g lies, via a space, opposite the upper cover 8 provided on the outer peripheral side of the opening 8a for maintenance. The flange portion 10g includes a seal material 22 installed at a leading end portion thereof. The seal material 22 is formed of a soft elastic material, and can be easily detachably installed on the flange portion 10g by inserting a leading end portion of the flange portion 10g into an insertion groove portion 22a formed at an upper portion of the seal material 22. When the engine hood 10 is locked in the closed position, the seal material 22 installed on the flange portion 10g is elastically deformed to come into abutting contact with the upper cover 8 provided on the outer peripheral side of the opening 8a for maintenance to forma seal between a lower edge portion of the engine hood 10 and the upper cover 8. The flange portion 10g and the seal material 22 are disposed in cutout areas of the lock means 12.

In the embodiment configured as described above, the engine hood 10 covers the opening 8a for maintenance formed in the upper cover 8 covering the upper portion of the engine room 6, and is held in the closed position by the lock means. Moreover, the engine hood 10 includes the rubber stopper 18 mounted thereon via the mounting member 20 and which comes into abutting contact with the upper cover 8 in an elastic pressing manner with the engine hood 10 locked in the closed position by the lock means 12. The rubber stopper 18 includes the main body portion 18b having, on the front surface side thereof, the abutting-contact surface portion 18a that comes into abutting contact with the upper cover 8, the mounting leg portions 18c projecting from the rear surface side of the main body portion 18b and fitted into the respective mounting holes 20b drilled in the mounting member 20 so as to penetrate the mounting member 20 in order to mount the rubber stopper 18 on the mounting member 20, and the press-in recess portions 18d formed in the abutting-contact surface portion 18a in front-to-back alignment with the mounting leg portions 18c.

Thus, the rubber stopper 18, which comes into abutting contact with the upper cover 8 in an elastic pressing manner with the engine hood 10 locked in the closed position, allows suppression of vibration of the engine hood 10 caused by vibration of the machine body. This enables reliable prevention of defects such as noise resulting from the vibration of the engine hood 10, premature degradation of the seal material 22 that forms a seal between the engine hood 10 and the upper cover 8, and release of locking of the engine hood 10 in the closed position by the lock means 12. In this configuration, the rubber stopper 18 is easily mounted on the mounting member 20 by fitting the mounting leg portions 18c projecting from the rear surface side of the main body portion 18b into the respective mounting holes 20b drilled in the mounting member 20. Furthermore, when the mounting leg portions 18c are fitted into the respective mounting holes 20b, the mounting leg portions 18c penetrate the respective mounting holes 20b. This enables pulling of the leading end side of the mounting leg portion 18c projecting through the mounting hole 20b and pushing of the press-in recess portion 18d formed in the abutting-contact surface portion 18a in front-to-back alignment with the mounting leg portion 18c. Consequently, the operation of fitting the mounting leg portion 18c into the mounting member 20 can be easily and efficiently performed. As a result, the operability of mounting of the rubber stopper 18 on the mounting member 20 is substantially improved, allowing a replacement operation to be easily performed when the rubber stopper 18 needs to be replaced due to degradation, damage, or the like. Additionally, for example, when the rubber stopper is mounted using screws, a situation can be avoided vibration of the machine body or the like makes the screws loose, causing the rubber stopper to be detached.

Furthermore, in the rubber stopper 18 in this configuration, the main body portion 18b is shaped like a rectangular parallelepiped, and the mounting leg portion 18c is shaped like an ellipse in cross section such that the longitudinal direction of the mounting leg portion is parallel to the short side direction of the main body portion 18b, and a plurality of (in the embodiment, two) the mounting leg portions 18c is provided in a long side direction of the main body portion 18b. Since the mounting leg portion 18c is thus shaped like an ellipse in cross section such that the longitudinal direction of the mounting leg portion 18c is parallel to the short side direction of the main body portion 18b, the main body portion 18b can receive a load imposed thereon in the long side direction in a distributed manner. This enables an increase in resistance to displacement of the main body portion 18b in the long side direction. Moreover, since a plurality of the mounting leg portions 18c is provided in the longitudinal direction of the main body portion 18b, movement of the main body portion 18b in the long and short side directions can be reliably regulated. As a result, even when the abutting-contact target surface 8b of the upper cover 8 has a small area so as to make the opening 8a for maintenance as large as possible, a defect can be reliably avoided in which, for example, the abutting-contact surface portion 18a is displaced to detach from the abutting-contact target surface 8b of the upper cover 8.

Moreover, the abutting-contact surface portion 18a of the rubber stopper 18 has the groove portions 18e formed so that the contact area between the abutting-contact surface portion 18a and the upper cover 8 is smaller than the contact area between the rear surface of the main body portion 18b and the mounting member 20. As a result, even when heat in the engine room 6 may cause the rubber stopper 18 to stick to the upper cover 8 or the mounting member 20, the force by which the rubber stopper 18 sticks to the upper cover 8 is lower than the force by which the rubber stopper 18 sticks to the mounting member 20. This allows reliable avoidance of a situation where the abutting-contact surface portion 18a sticks to the painted surface of the upper cover 8, causing the rubber stopper 18 to detach from the mounting member 20.

Furthermore, since the groove portion 18e is formed to lead to the outer periphery of the abutting-contact surface portion 18a, sand and gravel are discharged to the outer peripheral side of the abutting-contact surface portion 18a via the groove portions 18e. Thus, even in a case of the rubber stopper 18 for the engine hood 10 provided in a working machine such as the excavator 1 which is used in a field with much sand and gravel, a situation can be prevented where sand and gravel adhere to the abutting-contact surface portion 18a of the rubber stopper 18 and rub and peel off the painted surface of the abutting-contact target surface 8b of the upper cover 8.

Moreover, the mounting leg portion 18c of the rubber stopper 18 includes, at the outer peripheral portion thereof, the locking projecting portion 18f that is locked, in a retaining manner, in the mounting hole 20b drilled in the mounting member 20, whereas the press-in recess portion 18d is formed to penetrate the main body portion 18b and lead to the inside of the mounting leg portion 18c provided on the inner peripheral side of the locking projecting portion 18f. Thus, the locking projecting portion 18f locked in the mounting hole 20b in a retaining manner can reliably prevent the rubber stopper 18 from being inadvertently detached from the mounting member 20. Furthermore, when the mounting leg portion 18c is fitted into the mounting hole 20b, the locking projecting portion 18f can be deformed so as to escape toward the inside of the mounting leg portion 18c because the press-in recess portion 18d is formed to lead to the inside the mounting leg portion 18c. Hence, the locking projecting portion 18f can pass easily through the mounting hole 20b, further facilitating mounting of the rubber stopper 18 on the mounting member 20.

Of course, the present invention is not limited to the above-described embodiment. For example, in the above-described embodiment, the two mounting leg portions are provided on the rubber stopper. However, three or more mounting leg portions may be provided. Moreover, in the above-described embodiment, the rubber stopper is mounted on the opening-closing cover side member (mounting member 20). However, the rubber stopper may be mounted on the cover body side member and brought into abutting contact with the opening-closing cover side member in an elastic pressing manner. Furthermore, according to the present invention, the cover body side members include a member fixed to the machine body side with the positional relation between the member and the cover body unchanged.

Moreover, the present invention is not limited to the rubber stopper for the engine hood provided in the excavator but can of course be implemented in a rubber stopper for an opening-closing cover provided in various working machines.

### INDUSTRIAL APPLICABILITY

The present invention can be utilized when a working machine such as a construction machine includes an opening-closing cover such as an engine hood which can be opened and closed.

### EXPLANATION OF REFERENCE NUMERALS

6 Engine room

8 Upper cover

8a Opening for maintenance

10 Engine hood

12 Lock means

18 Rubber stopper

18a Abutting-contact surface portion

18b Main body portion

18c Mounting leg portion

18d Press-in recess portion

18e Groove portion

18f Locking projecting portion

20 Mounting member

20b Mounting hole

1. A rubber stopper for an opening-closing cover in a working machine including: a cover body which covers a housing room in which apparatuses are housed, the cover body having an opening; an opening-closing cover which is able to be opened and closed and which covers the opening; and lock means for holding the opening-closing cover in a closed position, the rubber stopper being provided on a first member, which is one of the opening-closing cover and the cover body, and coming into abutting contact with a second member, which is the other of the opening-closing cover and the cover body, in an elastic pressing manner with the opening-closing cover locked in a closed position, and the rubber stopper comprising: a main body portion including, on a front surface side thereof, an abutting-contact surface portion that comes into abutting contact with the second member; a mounting leg portion projecting from a rear surface side of the main body portion and fitted into a mounting hole drilled in the first member so as to penetrate the first member in order to mount the rubber stopper on the first member; and a press-in recess portion formed in the abutting-contact surface portion in front-to-back alignment with the mounting leg portion.

2. The rubber stopper for an opening-closing cover according to claim 1, wherein the main body portion is shaped like a rectangular parallelepiped, whereas the mounting leg portion is shaped like an ellipse in cross section such that a longitudinal direction of the mounting kg portion is parallel to a short side direction of the main body portion, and the mounting leg portion is provided in plurality in a long side direction of the main body portion.

3. The rubber stopper for an opening-closing cover according to claim 1, wherein the abutting-contact surface portion of the rubber stopper is provided with a groove portion formed such that a contact area between the abutting-contact surface portion and the second member is smaller than a contact area between the rear surface of the main body portion and the first member.

4. The rubber stopper for an opening-closing cover according to claim 3, wherein the groove portion is formed to lead to an outer periphery of the abutting-contact surface portion.

5. The rubber stopper for an opening-closing cover according to claim 1, wherein the mounting leg portion of the rubber stopper includes, at an outer peripheral portion thereof, a locking projecting portion that is locked, in a retaining manner, in a mounting hole drilled in the first member, whereas the press-in recess portion is formed to penetrate the main body portion and lead to an inside of the mounting leg portion provided on an inner peripheral side of the locking projecting portion.

6. The rubber stopper for an opening-closing cover according to claim 2, wherein the abutting-contact surface portion of the rubber stopper is provided with a groove portion formed such that a contact area between the abutting-contact surface portion and the second member is smaller than a contact area between the rear surface of the main body portion and the first member.

7. The rubber stopper for an opening-closing cover according to claim 6, wherein the groove portion is formed to lead to an outer periphery of the abutting-contact surface portion.

8. The rubber stopper for an opening-closing cover according to claim 2, wherein the mounting leg portion of the rubber stopper includes, at an outer peripheral portion thereof, a locking projecting portion that is locked, in a retaining manner, in a mounting hole drilled in the first member, whereas the press-in recess portion is formed to penetrate the main body portion and lead to an inside of the mounting leg portion provided on an inner peripheral side of the locking projecting portion.

9. The rubber stopper for an opening-closing cover according to claim 3, wherein the mounting leg portion of the rubber stopper includes, at an outer peripheral portion thereof, a locking projecting portion that is locked, in a retaining manner, in a mounting hole drilled in the first member, whereas the press-in recess portion is formed to penetrate the main body portion and lead to an inside of the mounting leg portion provided on an inner peripheral side of the locking projecting portion.

10. The rubber stopper for an opening-closing cover according to claim 4, wherein the mounting leg portion of the rubber stopper includes, at an outer peripheral portion thereof, a locking projecting portion that is locked, in a retaining manner, in a mounting hole drilled in the first member, whereas the press-in recess portion is formed to penetrate the main body portion and lead to an inside of the mounting leg portion provided on an inner peripheral side of the locking projecting portion.
